(19) United States
(12) Patent Application Publication
(10) Pub. No.: US 2026/0149961 A1
(43) Pub. Date: May 28, 2026

(54) COMMUNICATION APPARATUS, RIC, METHOD, AND PROGRAM

(71) Applicant: NEC CORPORATION, Minato-ku, Tokyo (JP)

(72) Inventors: Yoshinori WATANABE, Tokyo (JP); Rumi Matsumura, Tokyo (JP); Kenji KAWAGUCHI, Tokyo (JP); Masayuki UEDA, Tokyo (JP); Hideki KOZUKA, Tokyo (JP); Katsunori DATE; Eiji TAKAHASHI, Tokyo (JP); Takeo ONISHI, Tokyo (JP)

(73) Assignee: NEC CORPORATION, Minato-ku, Tokyo (JP)

(21) Appl. No.: 19/123,486

(22) PCT Filed: Oct. 26, 2023
(86) PCT No.: PCT/JP2023/038682

§ 371 Date: Apr. 23, 2025

(30) Foreign Application Priority Data
Nov. 9, 2022 (JP) 2022-179653

(51) Int. Cl. H04W 8/18

(52) U.S. Cl. CPC H04W 8/186

(57) ABSTRACT

An object is to provide a communication apparatus that enables to collect a measurement item necessary for specifying a factor of deterioration in communication quality. A communication apparatus that communicates with a Radio Access Network Intelligent Controller (RIC), includes a reception unit that receives a request message for requesting to report measurement data related to a transport block transmitted between the communication apparatus and at least one communication terminal in association for each communication terminal, from the RIC 10 and a transmission unit that transmits a message including the measurement data associated for each communication terminal to the RIC, in a case where receiving the request message.

### TECHNICAL FIELD

The present disclosure relates to a communication apparatus, an RIC, a method, and a program.

### BACKGROUND ART

In recent years, a radio access network has been used in which a baseband unit and a radio unit of a base station are separated and the baseband unit and the radio unit are connected via a fronthaul. An Open-Radio Access Network (O-RAN) fronthaul specification defined by the O-RAN alliance defines specifications of a fronthaul between an O-RU (Radio Unit) corresponding to the radio unit, and an O-DU (Distributed Unit) and an O-CU (Central Unit) corresponding to the baseband unit. One object of the O-RAN fronthaul specification is to facilitate connection with an O-RU of a vendor different from a vendor of an O-DU, and to realize multi-vendor of a radio access network.

Non Patent Literature 1 defines technical specifications defined in the O-RAN alliance. Specifically, Non Patent Literature 1 defines E2 Service Model (E2SM) “Key Performance Measurement” (KPM). The E2SM KPM defines an operation for reporting a performance measurement result at a cell level regarding a Radio Access Network (RAN) function of a 5th generation (5G) network.

Furthermore, in the chapter 7.9 of Non Patent Literature 1, a list of measurement items is illustrated that can be collected for each User Equipment (UE), among measurement items defined in Non Patent Literature 2 which is a technical specification of the 3rd Generation Partnership Project (3GPP)(registered trademark) and measurement items defined in the chapter 7.10 of Non Patent Literature 1.

It is expected to monitor communication quality of the RAN by measuring the performance regarding the RAN function of the 5G network and to use the measurement result to improve the communication quality.

### CITATION LIST

### Non Patent Literature

Non Patent Literature 1: O-RAN.WG3.E2SM-KPM-v02.03

Non Patent Literature 2: 3GPP TS28.552 V18.0.0(2022-09)

### SUMMARY OF INVENTION

### Technical Problem

A factor for deteriorating communication quality of a RAN is, for example, a delay caused by retransmission control. The retransmission control is executed in a case where a transmission error occurs. Specifically, the retransmission control is executed using a Hybrid Automatic Repeat reQuest (HARQ) in a medium access control (MAC) layer. Whether or not the delay occurs due to the retransmission control in the MAC layer can be determined by monitoring whether or not an error occurs in a transport block constituting the MAC layer for each UE. However, in Non Patent Literature 1, an item regarding the transport block constituting the MAC layer is not defined as a measurement item that can be collected for each UE. Therefore, Non Patent Literature 1 has a problem in that it is not possible to specify occurrence of the delay due to the retransmission control, as the factor of the deterioration in the communication quality. Furthermore, Non Patent Literature 1 has a problem in that it is not possible to specify another factor of communication quality deterioration, that is found by monitoring whether or not an error occurs in the transport block for each UE. The another factor of the communication quality deterioration includes, for example, a decrease in a throughput, an increase in an error occurrence rate, or the like caused by selection of an inappropriate Modulation and Coding Scheme (MCS) index in the MAC layer.

One object of the present disclosure is to provide a communication apparatus, an RIC, a method, and a program that can collect a measurement item necessary for specifying a factor of deterioration in communication quality, in view of the above problems.

### Solution to Problem

A communication apparatus according to a first aspect of the present disclosure that communicates with a Radio Access Network Intelligent Controller (RIC), includes a reception unit that receives a request message for requesting to report measurement data related to a transport block transmitted between the communication apparatus and at least one communication terminal in association for each communication terminal, from the RIC and a transmission unit that transmits a message including the measurement data associated for each communication terminal to the RIC, in a case where receiving the request message.

An RIC according to a second aspect of the present disclosure includes a transmission unit that transmits a request message for requesting to report measurement data related to a transport block transmitted between a communication apparatus and at least one communication terminal in association for each communication terminal, to the communication apparatus and a reception unit that receives a message including the measurement data associated for each communication terminal, from the communication apparatus that has received the request message.

A method according to a third aspect of the present disclosure is a method executed by a Radio Access Network Intelligent Controller (RIC), and includes a step of transmitting a request message for requesting to report measurement data related to a transport block transmitted between a communication apparatus and at least one communication terminal in association for each communication terminal, to the communication apparatus and a step of receiving a message including the measurement data associated for each communication terminal, from the communication apparatus that has received the request message.

A program according to a fourth aspect of the present disclosure causes a computer to transmit a request message for requesting to report measurement data related to a transport block transmitted between a communication apparatus and at least one communication terminal in association for each communication terminal, to the communication apparatus and receive a message including the measurement data associated for each communication terminal, from the communication apparatus that has received the request message.

### Advantageous Effects of Invention

According to the present disclosure, it is possible to provide a communication apparatus, an RIC, a method, and a program that can collect a measurement item necessary for specifying a factor of deterioration in communication quality.

### BRIEF DESCRIPTION OF DRAWINGS

FIG. 1A is a configuration diagram of an RIC according to the present disclosure.

FIG. 1B is a configuration diagram of a communication apparatus according to the present disclosure.

FIG. 1C is a diagram illustrating a method executed by the RIC according to the present disclosure.

FIG. 1D is a diagram illustrating a method executed by the communication apparatus according to the present disclosure.

FIG. 2 is a configuration diagram of a communication system according to the present disclosure.

FIG. 3 is a configuration diagram of a Near-RT RIC according to the present disclosure.

FIG. 4 is a configuration diagram of an O-DU according to the present disclosure.

FIG. 5 is a diagram illustrating a flow of processing regarding collection of measurement data according to the present disclosure.

FIG. 6 is a diagram illustrating a format of RIC ACTION DEFINITION IE according to the present disclosure.

FIG. 7 is a diagram illustrating a format of Subscription Information according to the present disclosure.

FIG. 8 is a diagram illustrating a data table illustrating measurement data that can be set to Measurement Name according to the present disclosure.

FIG. 9 is a diagram illustrating a data table illustrating the measurement data that can be set to Measurement Name according to the present disclosure.

FIG. 10 is a diagram illustrating the format of the RIC ACTION DEFINITION IE according to the present disclosure.

FIG. 11 is a diagram illustrating a flow of measurement data transmission processing according to the present disclosure.

FIG. 12 is a diagram illustrating a format of RIC INDICATION MESSAGE IE according to the present disclosure.

FIG. 13 is a diagram illustrating the format of RIC INDICATION MESSAGE IE according to the present disclosure.

FIG. 14 is a diagram illustrating a flow of measurement data collection processing, executed by the Near-RT RIC according to the present disclosure.

FIG. 15 is a diagram illustrating a flow of measurement data transmission processing executed by an E2 node 50 according to the present disclosure.

FIG. 16 is a configuration diagram of the Near-RT RIC, an O-CU, and the O-DU according to the present disclosure.

### EXAMPLE EMBODIMENT

### First Example Embodiment

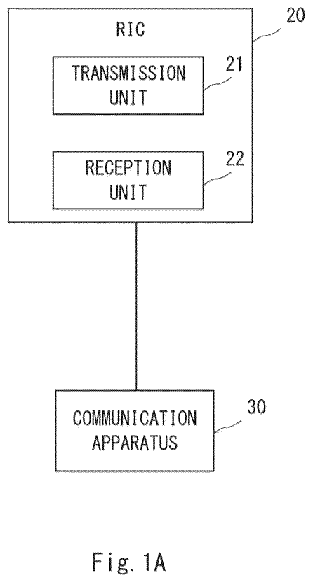

FIG. 1A illustrates a configuration example of a communication system 10 including a Radio Access Network Intelligent Controller (RIC) 20 and a communication apparatus 30. The communication apparatus 30 may be, for example, a base station apparatus. Alternatively, the communication apparatus 30 may be an O-RAN Central Unit (O-CU) or an O-RAN Distributed Unit (O-DU) constituting a RAN architecture defined in an O-RAN alliance. The O-CU and the O-DU may be referred to as a CU and a DU. The RIC 20 may be a logical node that optimizes a RAN element or a RAN resource. The logical node may be responsible for processing corresponding to a function. Alternatively, the RIC 20 may be a physical apparatus corresponding to an entity. Furthermore, the name of the RIC is not limited to this. That is, the RIC 20 according to the present example embodiment may be a logical node or a physical apparatus (for example, management node and management apparatus) having another name and having functions equivalent to the RIC 20. Similarly, the O-CU and the O-DU may be logical nodes or physical apparatuses.

Here, a configuration example of the RIC 20 illustrated in FIG. 1A will be described. The RIC 20 includes a transmission unit 21 and a reception unit 22. The transmission unit 21 and the reception unit 22 may be software components or modules whose processing is carried out by causing a processor to execute a program stored in a memory. Alternatively, the transmission unit 21 and the reception unit 22 may be hardware components such as circuits or chips.

The RIC 20 communicates with the communication apparatus 30. For example, the RIC 20 collects information held by each communication apparatus 30, so as to design a parameter of the communication apparatus 30 that is the RAN element or to optimize an operation of the communication apparatus 30.

Specifically, the transmission unit 21 transmits a request message for requesting to report measurement data related to a transport block transmitted between the communication apparatus 30 and at least one communication terminal in association for each communication terminal, to the communication apparatus 30. Note that the RIC 20 according to the present example embodiment may be a Near-Real-Time (Near-RT) RIC. Alternatively, the RIC 20 may be a Non-Real-Time (Non-RT) RIC.

The transport block indicates, for example, a unit of data mapped to a physical channel or a physical layer such as a Physical Downlink Shared Channel (PDSCH) or a Physical Uplink Shared Channel (PUSCH). Mapping of the transport block to the physical channel is performed in a MAC layer. The measurement data related to the transport block is data indicating a measurement result of data in units of transport blocks. The measurement data may be, for example, the number of transport blocks transmitted between the communication terminal and the communication apparatus 30, the number of transport blocks in which an error has occurred, or the like. Furthermore, the measurement data may include measurement data regarding the transport block transmitted from the communication terminal to the communication apparatus 30 and measurement data regarding the transport block transmitted from the communication apparatus 30 to the communication terminal. Data transmission from the communication terminal to the communication apparatus 30 corresponds to uplink communication, and data transmission from the communication apparatus 30 to the communication terminal corresponds to downlink communication.

The reception unit 22 receives a message including the measurement data associated for each communication terminal, from the communication apparatus 30 that has received the request message.

Subsequently, a configuration example of the communication apparatus 30 illustrated in FIG. 1B will be described. The communication apparatus 30 includes a reception unit 31 and a transmission unit 32. The reception unit 31 and the transmission unit 32 may be software components or modules whose processing is carried out by causing the processor to execute the program stored in the memory. Alternatively, the reception unit 31 and the transmission unit 32 may be hardware components such as circuits or chips.

The reception unit 31 receives a request message for requesting to report the measurement data related to the transport block transmitted between the communication apparatus 30 and at least one communication terminal in association for each communication terminal, from the RIC 20.

Upon receiving the request message, the transmission unit 32 transmits a message including the measurement data associated for each communication terminal to the RIC 20. The communication apparatus 30 may collect measurement data associated for each communication terminal from another communication apparatus. Alternatively, the communication apparatus 30 may generate the measurement data related to the transport block, for each communication terminal. The communication apparatus 30 transmits a message including identification information of the communication terminal and measurement data associated with the identification information to the RIC 20.

Subsequently, a method executed by the RIC 20 will be described with reference to FIG. 1C. First, the transmission unit 21 transmits the request message for requesting to report the measurement data related to the transport block transmitted between the communication apparatus 30 and at least one communication terminal in association for each communication terminal, to the communication apparatus 30 (S1). Next, the reception unit 22 receives the message including the measurement data associated for each communication terminal, from the communication apparatus 30 that has received the request message (S2).

Subsequently, a method executed by the communication apparatus 30 will be described with reference to FIG. 1D. First, the reception unit 31 receives the request message for requesting to report the measurement data related to the transport block transmitted between the communication apparatus 30 and at least one communication terminal in association for each communication terminal, from the RIC 20 (S5). Next, upon receiving the request message, the transmission unit 32 transmits the message including the measurement data associated for each communication terminal to the RIC 20 (S6).

As described above, the RIC 20 requests the communication apparatus 30 to report of the measurement data related to the transport block, associated for each communication terminal and acquires the measurement data associated for each communication terminal, from the communication apparatus 30. As a result, the RIC 20 can analyze data regarding the transport block for each communication terminal. Therefore, the RIC 20 can specify a factor of communication quality deterioration. Specifically, the RIC 20 can determine whether or not the factor of the communication quality deterioration relates to whether or not an error has occurred in the transport block.

### Second Example Embodiment

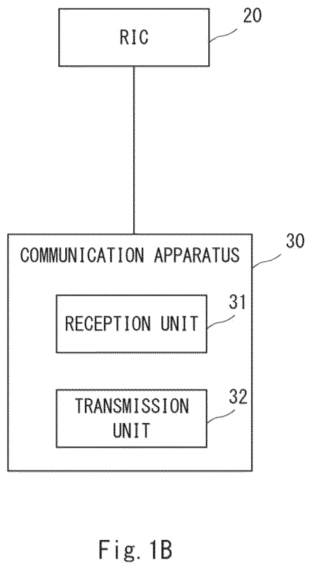

Subsequently, a configuration example of a communication system will be described with reference to FIG. 2. The communication system in FIG. 2 includes a Near-Real-Time (Near-RT) RIC 40, an E2 node 50, an O-RU 80, a Service Management and Orchestration (SMO) 90, and a UE 110. Moreover, the E2 node 50 includes an O-CU 60 and an O-DU 70. Furthermore, the SMO 90 includes a Non-Real-Time (Non-RT) RIC 100. Each apparatus included in the communication system may be a computer apparatus that operates in a case where a processor executes a program stored in a memory.

The UE 110 is used as a general term for a communication terminal. For example, the UE 110 may be a mobile phone terminal, a smartphone terminal, or an Internet of Things (IoT) terminal. The UE 110 may support a wireless communication standard, so called 5G, in order to perform wireless communication with the O-RU 80.

The E2 node 50 is a logical node that terminates an E2 interface. The E2 interface is an interface defined between the E2 node 50 and the Near-RT RIC 40. That is, the E2 interface is an interface defined between the O-CU 60 and the Near-RT RIC 40, and further between the O-DU 70 and the Near-RT RIC 40. The E2 node 50 may be a physical apparatus corresponding to one of the O-CU 60 and the O-DU 70 and may be a physical apparatus in which the O-CU 60 and the O-DU 70 are integrated. In a case where the E2 node 50 is the physical apparatus in which the O-CU 60 and the O-DU 70 are integrated, the E2 interface is an interface defined between the physical apparatus in which the O-CU 60 and the O-DU 70 are integrated and the Near-RT RIC 40.

The O-CU 60 may be, for example, a logical node that hosts a Radio Resource Control (RRC) and a Packet Data Convergence Protocol (PDCP). Alternatively, the O-CU 60 may be a physical apparatus on which an O-CU that is a logical node is mounted. Hosting (host) the RRC and the PDCP may be paraphrased as terminating an RRC protocol or the PDCP, executing processing regarding the RRC protocol and the PDCP, or the like. Furthermore, hosting the RRC and the PDCP by the O-CU 60 may be paraphrased as executing processing regarding an RRC layer and a PDCP layer by the O-CU 60, or the like. In the following description, the term “hosting” may be paraphrased as described above.

The O-CU that executes processing regarding a Control Plane (C-Plane) part of the PDCP may be referred to as an O-CU-C-Plane (CP). Moreover, the O-CU that executes processing regarding a User Plane (U-Plane) part of the PDCP may be referred to as an O-CU-U-Plane (UP).

The O-DU 70 may be a logical node that hosts Radio Link Control (RLC) and Medium Access Control (MAC). Moreover, the O-DU 70 may be a logical node that hosts an upper function of a physical (PHY) layer. Alternatively, the O-DU 70 may be a physical apparatus on which an O-DU that is a logical node is mounted. Furthermore, the O-DU 70 may execute the processing regarding the PDCP, instead of the O-CU 60 or together with the O-CU 60. The upper function of the physical layer may be, for example, encoding and modulation processing, and in addition, decoding and demodulation processing, or the like.

The O-RU 80 may be a logical node that hosts or executes a lower function of the physical layer or Radio Frequency (RF) processing.

Alternatively, the O-RU 80 may be a physical apparatus on which an O-RU that is a logical node is mounted. The lower function of the physical layer may be, for example, Fast Fourier Transform (FFT)/Inverse FFT (IFFT) processing, Beam Forming (BF) processing, and the like.

The SMO 90 manages or supports a RAN domain. In other words, the SMO 90 controls or optimizes the RAN domain. The RAN domain may be, for example, a network including the O-CU 60, the O-DU 70, and the O-RU 80.

For example, the SMO 90 may support a FCAPS regarding the Near-RT RIC 40, the O-CU 60, and the O-DU 70 via an Ol interface. The FCAPS indicates functions for executing Fault Management (Fault Management), Configuration Management (Configuration Management), Accounting Management (Accounting Management), Performance Management (Performance Management), and Security Management (Security Management). Furthermore, the SMO 90 may support the FCAPS regarding the O-RU 80.

Furthermore, the Non-RT RIC 100 included in the SMO 90 may execute processing regarding optimization of the RAN, for example, by communicating with the Near-RT RIC 40 via an Al interface. The optimization of the RAN may be, for example, generating a control policy regarding the RAN and sending the control policy to the Near-RT RIC 40.

The Near-RT RIC 40 is a logical function that performs near real time (near real time) control and optimization of the RAN element and resource.

Alternatively, the Near-RT RIC 40 may be a physical apparatus that mounts a logical function for performing near real time (near real time) control and optimization of the RAN element and resource. The RAN element may be, for example, the O-CU 60 and the O-DU 70. Specifically, the Near-RT RIC 40 collects fine grained data (fine grained data) from the O-CU 60 or the O-DU 70 via the E2 interface. The near real time control may be, for example, control performed in a period of 10 ms to about one ms. The fine grained data may be, for example, referred to as near real time information. The near real time information may be, for example, information in UE units or information in cell units.

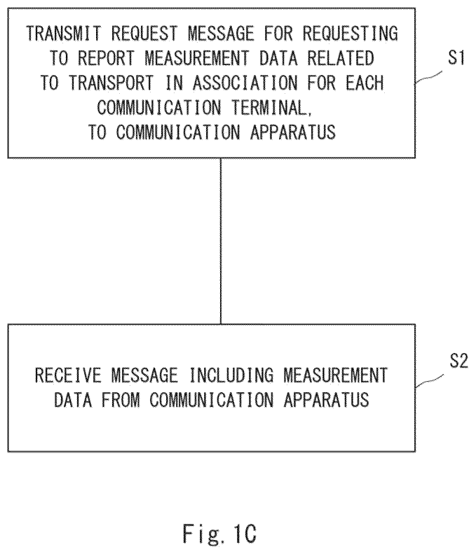

Subsequently, a configuration example of the Near-RT RIC 40 will be described with reference to FIG. 3. The Near-RT RIC 40 includes a control unit 41 and a communication unit 42. The control unit 41 and the communication unit 42 may be software components or modules whose processing is carried out by causing the processor to execute the program stored in the memory. Alternatively, the control unit 41 and the communication unit 42 may be hardware components such as circuits or chips.

The control unit 41 generates a request message for requesting the E2 node 50 to report information, in order to collect information from the E2 node 50. The information collected by the control unit 41 may be, for example, measurement data regarding the transport block transmitted between the UE 110 and the O-RU 80. The measurement data regarding the transport block may be data regarding the MAC layer. Processing regarding the MAC layer is executed by the O-DU 70. Therefore, the control unit 41 may set a destination of the request message to the O-DU 70. That is, in a case of collecting the measurement data regarding the transport block, the Near-RT RIC 40 may transmit the request message to the O-DU 70, as the E2 node 50.

Moreover, the control unit 41 may determine whether or not an error occurs in the transport block, between the UE 110 and the O-RU 80, using the measurement data received from the E2 node 50. Moreover, in a case of detecting that an error occurrence rate in the transport block is higher than a predetermined value, the control unit 41 may analyze a factor of deterioration in communication quality caused between the UE 110 and the O-RU 80. Alternatively, in a case of detecting that the error occurrence rate is lower than the predetermined value, the control unit 41 may analyze the factor of the deterioration in the communication quality caused between the UE 110 and the O-RU 80.

The communication unit 42 transmits the request message for requesting the E2 node 50 to report the information via the E2 interface and receives a message including the measurement data.

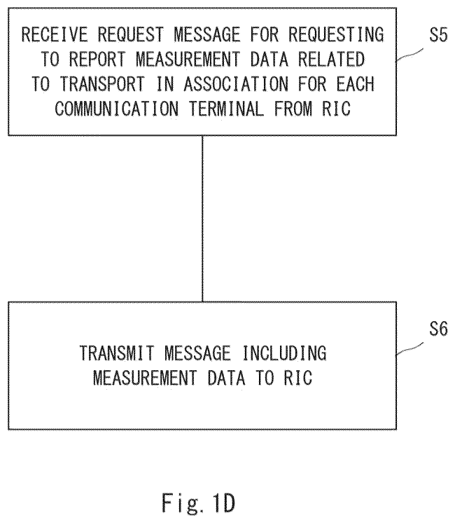

Subsequently, a configuration example of the O-DU 70 will be described with reference to FIG. 4. The O-DU 70 includes a control unit 71 and a communication unit 72. The control unit 71 and the communication unit 72 may be software components or modules whose processing is carried out by causing the processor to execute the program stored in the memory. Alternatively, the control unit 71 and the communication unit 72 may be hardware components such as circuits or chips.

The control unit 71 receives the request message for requesting to report the measurement data regarding the transport block, from the Near-RT RIC 40 via the communication unit 72. Upon receiving the request message, the control unit 71 generates a message including the measurement data regarding the transport block. The control unit 71 transmits the message including the measurement data to the Near-RT RIC 40 via the communication unit 72. The control unit 71 includes information regarding the number of transport blocks in which an error occurs in the MAC layer, the number of transport blocks transmitted and received between the UE 110 and the O-RU 80, or the like, in the message, as the measurement data.

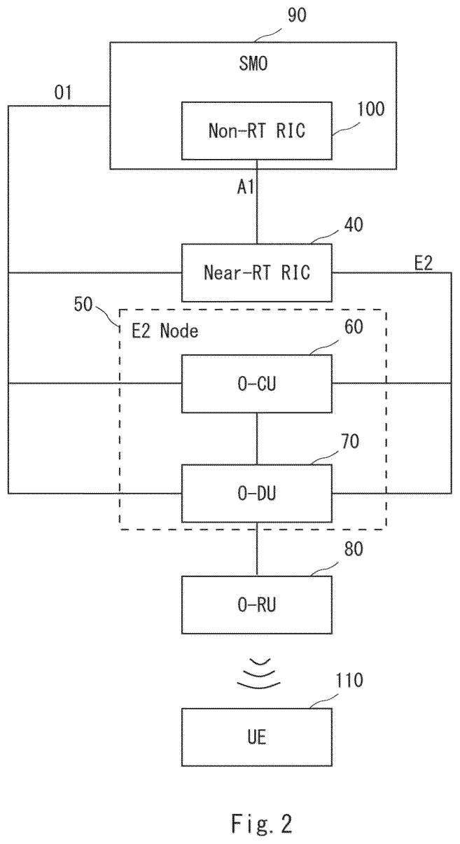

Subsequently, a flow of processing regarding the collection of the measurement data by the Near-RT RIC 40 and the E2 node 50 will be described with reference to FIG. 5. Note that, in FIG. 5, for the purpose of collecting measurement data regarding the MAC layer, the E2 node 50 may be specifically the O-DU 70. Furthermore, FIG. 5 refers to O-RAN.WG3.E2AP-v02.02 that defines specifications regarding the E2 Application Protocol (E2AP) in the O-RAN alliance.

First, the Near-RT RIC 40 transmits a RIC SUBSCRIPTION REQUEST message to the E2 node 50 (S11). The RIC SUBSCRIPTION REQUEST message includes RIC ACTION DEFINITION IE as an information element (information element).

The RIC ACTION DEFINITION IE may be used to request execution of E2 REPORT service by the O-DU 70. Requesting the execution of the E2 REPORT service may be paraphrased as triggering the E2 REPORT service. The E2 REPORT service may be simply referred to as REPORT service. The REPORT service may be, for example, disclosing (expose) information regarding RAN control and the UE held by the O-DU 70. Disclosing the information regarding the RAN control and the UE by the O-DU 70 may be transmitting the information regarding the RAN control and the UE to the Near-RT RIC 40 by the O-DU 70. The information disclosed by the O-DU 70 may be, for example, information regarding a cell, information regarding an E2 node, or information regarding a UE. The O-DU 70 may transmit the information regarding the cell, the information regarding the E2 node, or the information regarding the UE to the Near-RT RIC 40, each time when the execution of the REPORT service is requested from the Near-RT RIC 40. The information regarding the cell, the information regarding the E2 node, and the information regarding the UE may be, for example, E2 Node Information, Cell related Information, and UE Information used to monitor changes occurring in the cell, the E2 node, and the UE.

The Near-RT RIC 40 selects a format corresponding to the collection of the measurement data and sets information for designating measurement data to be collected, to the selected format. For example, the Near-RT RIC 40 collects the measurement data regarding the transport block in UE units or for each UE.

In this case, a format 2 that can set a UE ID that is identification information of a UE that is a measurement data collection target may be set. Here, the format refers to E2SM-KPM-Action Definition Formats 1 to 5 defined in Non-Patent Literature 1. For example, the format 2 corresponds to the E2SM-KPM-Action Definition Format 2, and the format 1 corresponds to the E2SM-KPM-Action Definition Format 1.

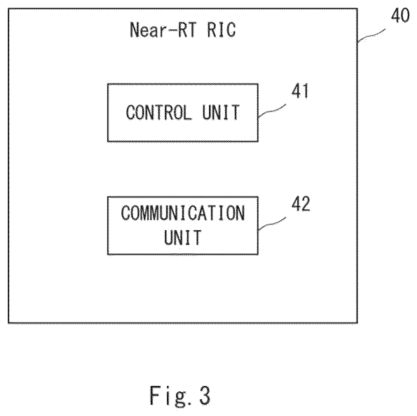

Here, the format 2 that can be selected as the format of the RIC ACTION DEFINITION IE will be described with reference to FIG. 6. As illustrated in FIG. 6, the format 2 indicates a format in which the UE ID can be set. Furthermore, to Subscription Information in the format 2, the format 1 that can set the measurement data to be collected is set.

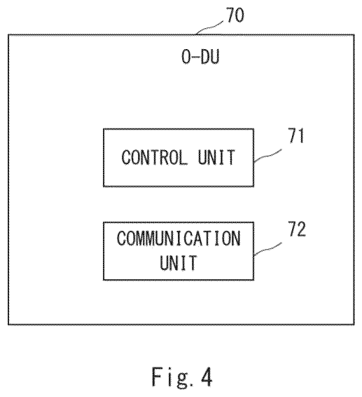

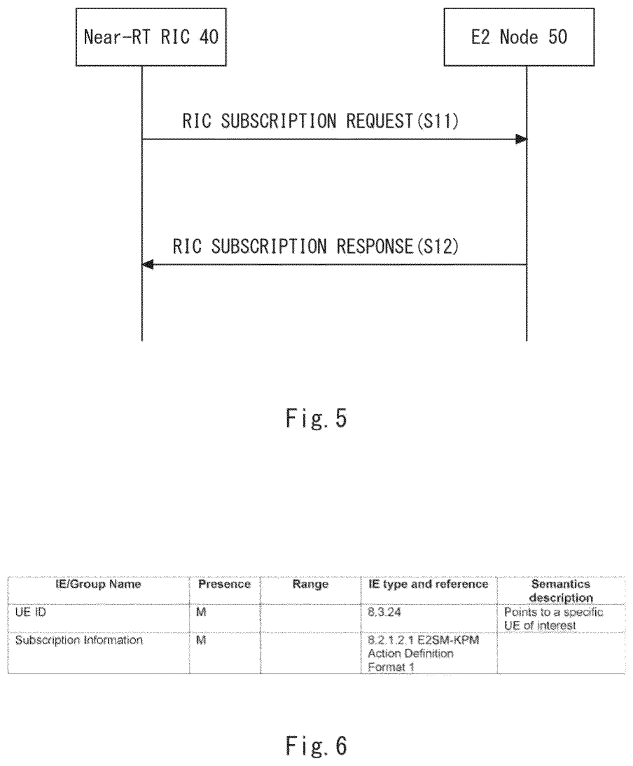

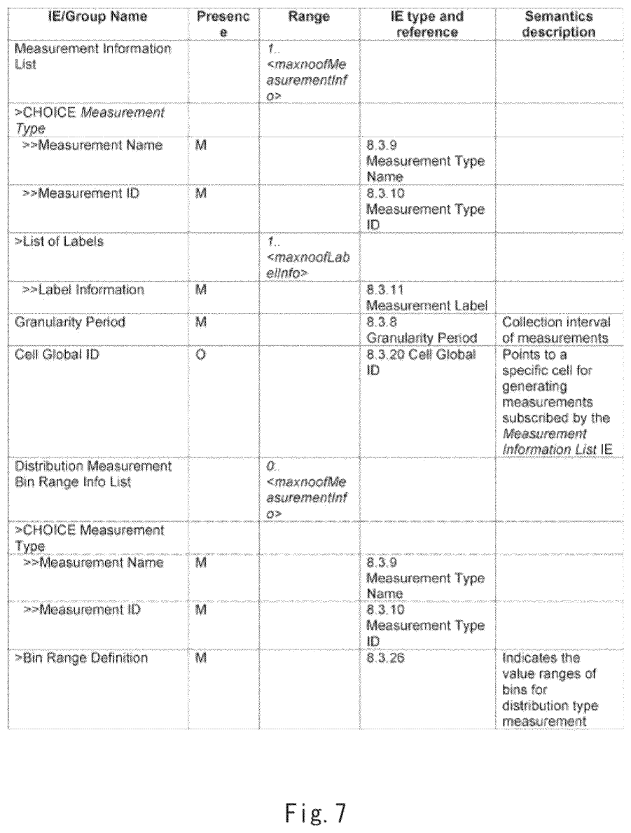

Here, the format 1 that can be selected as a format of the Subscription Information will be described with reference to FIG. 7. The measurement data to be collected may be set to Measurement Name indicated in the format 1, for example. Here, a data table indicating the measurement data that can be set to the Measurement Name indicated in the format 1 will be described with reference to FIGS. 8 and 9. The data tables illustrated in FIGS. 8 and 9 illustrate a list of measurement data that can be measured in UE units. Although the data table is divided into FIGS. 8 and 9 due to restriction of drawing creation, a single data table may be illustrated. That is, as in FIGS. 8 and 9, data related to “The type of the original measurements”, “The corresponding per-UE and per-UE-per slice measurements”, “The corresponding per-QoS-flow and per-slice-per-QoS flow measurements”, and “Notes” is illustrated.

The Near-RT RIC 40 may store the data tables illustrated in FIGS. 8 and 9 in the memory or the like. Specifically, in Non Patent Literature 2, a list of parameter names in a group corresponding to “The type of the original measurements” illustrated in FIGS. 8 and 9 may be stored in the memory or the like as the data table. For example, for “TB related” in FIG. 9, a parameter name such as “Total error number of DL TBs” of a group of “TB related Measurements” in Non Patent Literature 2 may be stored in the memory or the like. In this case, the Near-RT RIC 40 may refer to the data table and select the measurement data to be set to the Measurement Name in the format 1. Furthermore, in a case where the Near-RT RIC 40 is instructed to set measurement data other than the measurement data indicated in the data table illustrated in FIGS. 8 and 9, the Near-RT RIC 40 may output an error message.

As the measurement data regarding the transport block, “Total number of UL initial TBs”, “Total number of DL initial TBs”, “Initial error number of DL TBs”, “Error number of UL initial TBs”, “Total number of UL TBs”, “Total number of DL TBs”, “Total error number of UL TBs”, “Total error number of DL TBs”, “Residual error number of UL TBs”, and “Residual error number of DL TBs” are illustrated in FIG. 9.

For example, “Total number of (UL/DL) TBs” indicates the number of transport blocks transferred between the designated UE and the O-RU 80. Furthermore, the Near-RT RIC 40 can designate whether to collect the number of transport blocks in the uplink or to collect the number of transport blocks in the downlink, by designating the UL or DL. Alternatively, the Near-RT RIC 40 can designate a total number of transport blocks in the uplink and the downlink.

Furthermore, “Total error number of (UL/DL) TBs” indicates the number of transport blocks including errors, among the transport blocks transferred between the designated UE and the O-RU 80. Similarly to “Total number of (UL/DL) TBs”, the Near-RT RIC 40 can designate the uplink or the downlink and can designate the uplink and the downlink, in “Total error number of (UL/DL) TBs”.

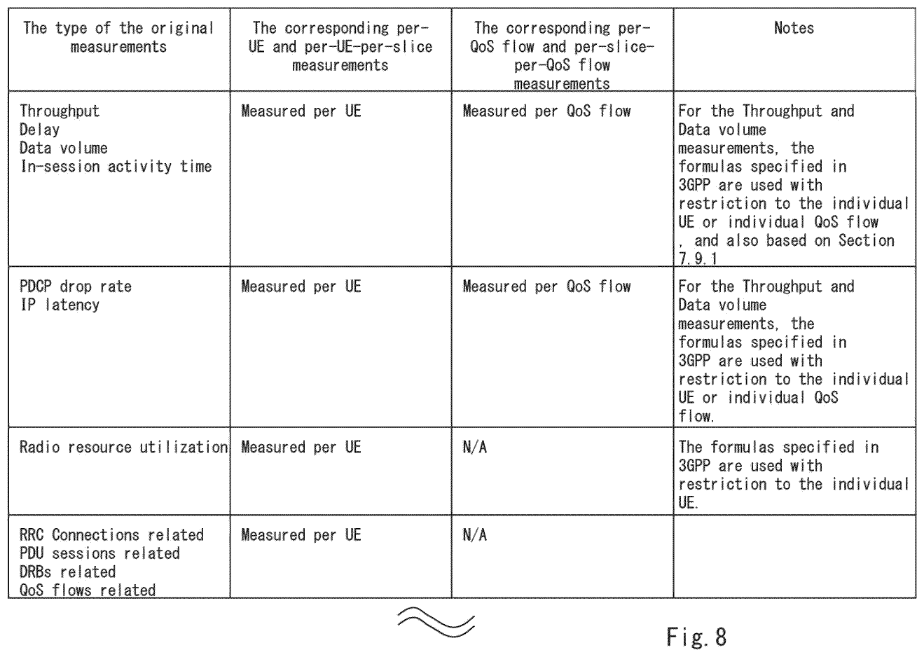

Furthermore, as the format in which the UE ID can be set, a format 5 illustrated in FIG. 10 may be used, instead of the format 2. The format 5 corresponds to the E2SM-KPM-Action Definition Format 5. Alternatively, a format 3 or 4 that designates a predetermined condition and returns measurement data of a UE that satisfies the condition in UE units may be used. The formats 3 and 4 respectively correspond to the E2SM-KPM-Action Definition Formats 3 and 4.

Returning to FIG. 5, the E2 node 50 transmits an RIC SUBSCRIPTION RESPONSE message upon receiving the RIC SUBSCRIPTION REQUEST message (S12). The Near-RT RIC 40 may start a timer in a case where transmitting the RIC SUBSCRIPTION REQUEST message. For example, the timer may be used to determine whether or not the RIC SUBSCRIPTION RESPONSE message can be received within a predetermined period, after the transmission of the RIC SUBSCRIPTION REQUEST message. The timer may expire and be stopped in a case where the predetermined period has elapsed. Alternatively, the timer may expire in a case where the predetermined period has elapsed and count the predetermined period again.

In a case of receiving the RIC SUBSCRIPTION RESPONSE message within the predetermined period, the Near-RT RIC 40 may determine that the RIC SUBSCRIPTION REQUEST message has been successfully accepted in the E2node 50. In this case, the Near-RT RIC 40 may end the timer in a case where receiving the RIC SUBSCRIPTION RESPONSE message. In a case where the RIC SUBSCRIPTION RESPONSE message is not received within the predetermined period, the Near-RT RIC 40 may determine that the RIC SUBSCRIPTION REQUEST message has not been successfully accepted. In this case, the Near-RT RIC 40 may transmit the RIC SUBSCRIPTION REQUEST message again or end the processing regarding the RIC SUBSCRIPTION REQUEST.

Alternatively, in a case where the E2 node 50 determines not to execute the REPORT service, the Near-RT RIC 40 may receive an RIC SUBSCRIPTION FAILURE message from the E2 node 50. In a case of receiving the RIC SUBSCRIPTION FAILURE message, the Near-RT RIC 40 may end the timer.

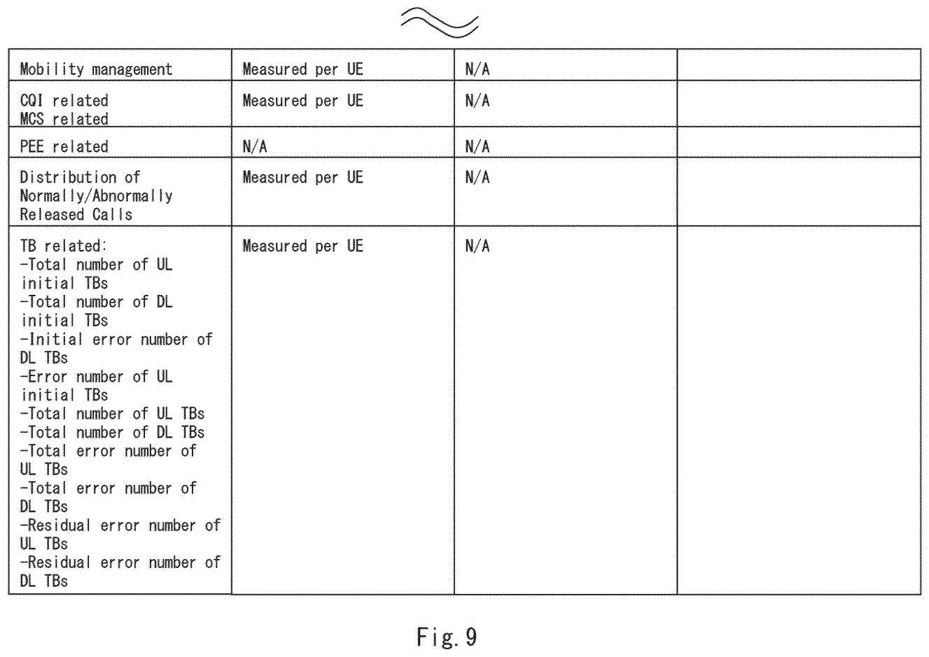

Subsequently, measurement data transmission processing will be described with reference to FIG. 11. The E2 node 50 receives the RIC SUBSCRIPTION REQUEST message in the processing in FIG. 5. Thereafter, the E2 node 50 generates measurement data regarding a transport block transmitted and received with the O-RU 80, for the UE specified from information regarding the RIC ACTION DEFINITION IE.

The E2 node 50 transmits an RIC INDICATION message including the generated measurement data to the Near-RT RIC 40 (S21). The RIC INDICATION message may be a message used to execute the REPORT service. The RIC INDICATION message includes RIC INDICATION MESSAGE IE to which the measurement data is set.

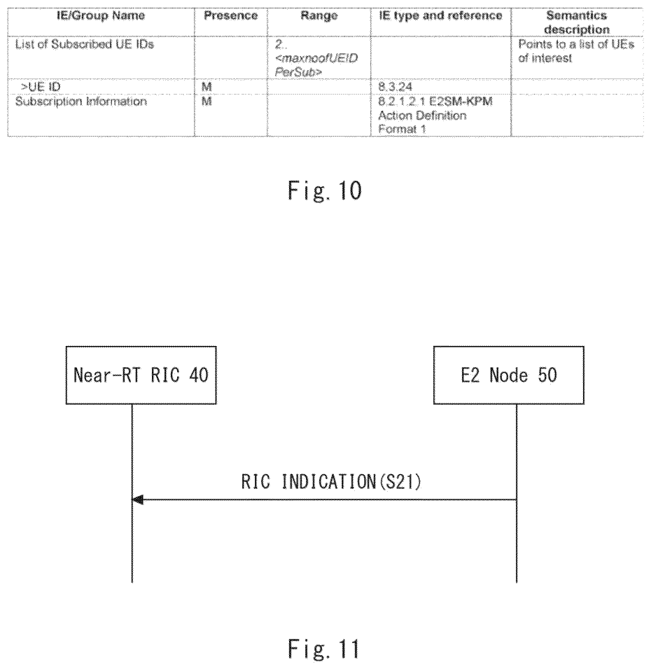

The E2 node 50 selects a format corresponding to the report of the measurement data and sets the generated measurement data to the selected format. Here, the format 1 selected as the format of the RIC INDICATION MESSAGE IE will be described with reference to FIG. 12. The format refers to E2SM-KPM Indication Message Formats 1 to 3 described in Non Patent Literature 1. In a case where the E2SM-KPM-Action Definition Format 2 is selected in step S11 in FIG. 5, the E2 node 50 selects the format 1 (E2SM-KPM Indication Message Format 1). Furthermore, in a case where the E2SM-KPM-Action Definition Format 3 is selected in step S11 in FIG. 5, the E2 node 50 selects the format 2 (E2SM-KPM Indication Message Format 2). Furthermore, in a case where the E2SM-KPM-Action Definition Format 4 or 5 is selected in step S11 in FIG. 5, the E2 node 50 selects the format 3 (E2SM-KPM Indication Message Format 3).

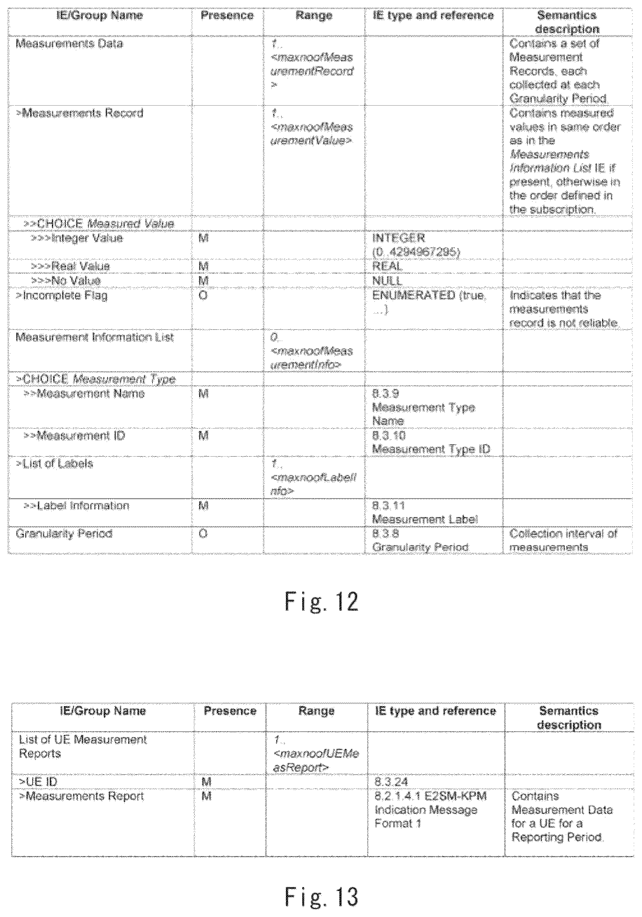

A value of the measurement data regarding the transport block is set to Measurement Record defined in IE/Group Name in the format 1 illustrated in FIG. 12. Specifically, the value of the measurement data is set to Integer Value in CHOICE Measured Value. Moreover, a measurement item regarding the measurement data is set to Measurement Name in CHOICE Measurement Type defined in the IE/Group Name in the format 1 illustrated in FIG. 12. Specifically, to the Measurement Name, any one of “Total number of DL initial TBs”, “Initial error number of DL TBs”, “Total number of DL TBs”, “Total error number of DL TBs”, “Residual error number of DL TBs”, “Total number of UL initial TBs”, “Error number of UL initial TBs”, “Total number of UL TBs”, “Total error number of UL TBs”, and “Residual error number of UL TBs” may be set. Furthermore, the format illustrated in FIGS. 12 and 13 may be used for each measurement item. That is, in a case where there are two measurement items, the format in FIG. 12 may be used for each measurement item. In other words, in the RIC INDICATION MESSAGE IE, the plurality of formats may be set according to the number of measurement items.

Here, the E2SM-KPM Indication Message Format 3 will be described with reference to FIG. 13. In the E2SM-KPM-Action Definition Format 5 that may be set in step S11 in FIG. 5, the plurality of UE IDs can be designated. Therefore, in the E2SM-KPM Indication Message Format 3, at least one UE ID designated in the E2SM-KPM-Action Definition Format 5, that is, a report target is set.

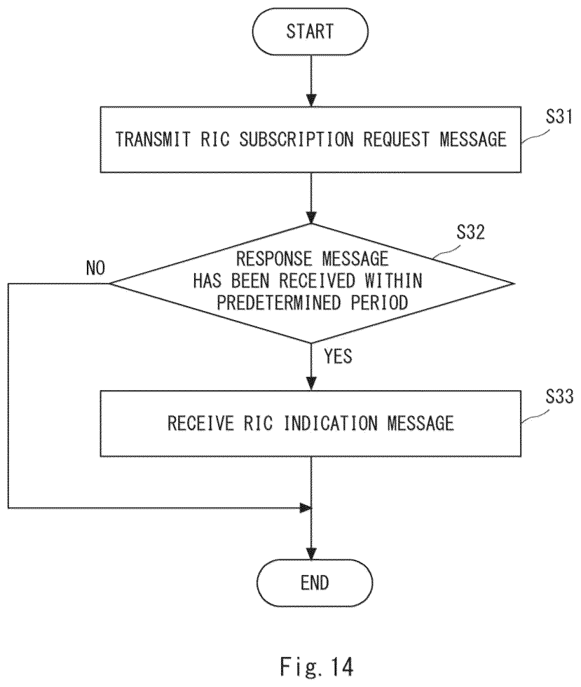

Subsequently, a flow of measurement data collection processing executed by the Near-RT RIC 40 will be described with reference to FIG. 14. First, the communication unit 42 transmits the RIC SUBSCRIPTION REQUEST message to the E2 node 50 (S31). As a destination of the RIC SUBSCRIPTION REQUEST message, for example, the O-DU 70 is set. Moreover, the RIC SUBSCRIPTION REQUEST message includes information used to specify a UE to be collected, such as the UE ID, and an item of the measurement data to be collected.

Furthermore, the control unit 41 starts the timer in a case where the RIC SUBSCRIPTION REQUEST message is transmitted from the communication unit 42.

Next, the control unit 41 determines whether or not the RIC SUBSCRIPTION RESPONSE message has been received from the E2 node 50 within a predetermined period (S32). The predetermined period may be paraphrased as before the timer expires.

In a case of determining that the RIC SUBSCRIPTION RESPONSE message has been received within the predetermined period, the control unit 41 receives the RIC INDICATION message thereafter (S33). In a case of determining that the RIC SUBSCRIPTION RESPONSE message has not been received within the predetermined period, the control unit 41 ends processing regarding the RIC SUBSCRIPTION REQUEST. For example, the control unit 41 may transmit an RIC SUBSCRIPTION DELETE REQUEST message to the E2node 50, in order to cancel the processing regarding the RIC SUBSCRIPTION REQUEST. Furthermore, in a case where the RIC SUBSCRIPTION RESPONSE message or the RIC INDICATION message is received after the predetermined period has elapsed, the control unit 41 may ignore the received message. Ignoring the received message may be paraphrased as discarding or deleting the received message.

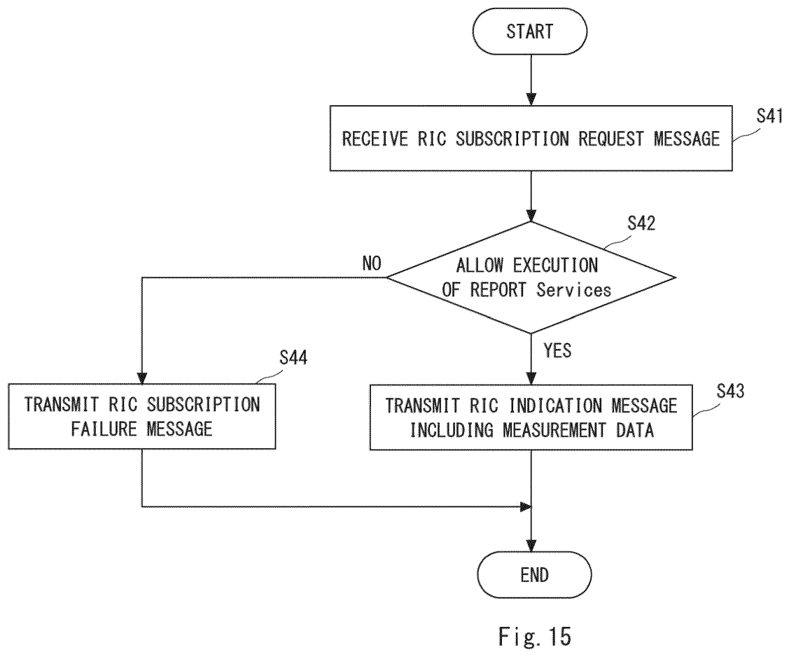

Subsequently, a flow of measurement data transmission processing executed by the E2 node 50 will be described with reference to FIG. 15. Here, the flow of the measurement data transmission processing executed, specifically, by the O-DU 70, as the E2 node 50 will be described.

First, the communication unit 72 receives the RIC SUBSCRIPTION REQUEST message (S41). Next, the control unit 71 determines whether or not to execute the REPORT service, in accordance with the RIC ACTION DEFINITION IE (S42). For example, in a case where a defect, inconsistency, or the like is included in setting content of the RIC ACTION DEFINITION IE, the control unit 71 may determine not to execute the REPORT service. In a case where the setting content of the RIC ACTION DEFINITION IE is appropriate, the control unit 71 may determine to execute the REPORT service.

In a case of determining to execute the REPORT service, the control unit 71 transmits the RIC INDICATION message including the measurement data to the Near-RT RIC 40 (S43). For example, the control unit 71 may set the number of transport blocks transmitted to the UE 110 in the MAC layer and the number of transport blocks received from the UE 110 respectively as measurement data regarding “Total number of DL TBs” and measurement data regarding “Total number of UL TBs”. Moreover, the control unit 71 may determine the number of transport blocks in which an error has occurred in the downlink by receiving feedback from the UE 110. Moreover, the control unit 71 may check the number of transport blocks received from the UE 110 and determine the number of transport blocks in which an error has occurred in the uplink. The number of transport blocks in which the error has occurred may be measurement data regarding each of “Total error number of DL TBs” and “Total error number of UL TBs”.

In a case of determining not to execute the REPORT Service, the control unit 71 may transmit the RIC SUBSCRIPTION FAILURE message to the Near-RT RIC 40 (S44).

As described above, the Near-RT RIC 40 can collect the measurement data regarding the transport block associated with the UE, from the E2 node 50. As a result, the Near-RT RIC 40 can determine whether or not the communication quality is deteriorated due to whether or not an error occurs in the transport block. Note that, in the present example embodiment, the Near-RT RIC 40 collects the measurement data regarding the transport block associated with the UE. However, the present example embodiment is not limited to this. That is, the Non-RT RIC 100 may collect the measurement data regarding the transport block associated with the UE. In this case, the Non-RT RIC 100 may collect the measurement data regarding the transport block associated with the UE, from the E2 node 50, using the O1 interface illustrated in FIG. 2. Alternatively, the Non-RT RIC 100 may collect the measurement data regarding the transport block associated with the UE, from the E2 node 50, using an interface different from the O1 interface illustrated in FIG. 2. Furthermore, the Non-RT RIC 100 may report the measurement data collected from the E2 node 50, to the Near-RT RIC 40 using the A1 interface.

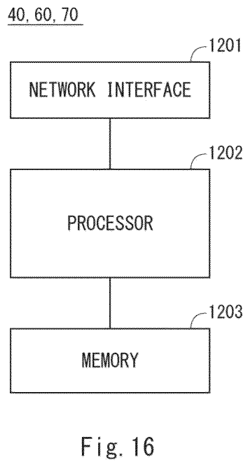

FIG. 16 is a block diagram illustrating a configuration example of the Near-RT RIC 40, the O-CU 60, and the O-DU 70 (hereinafter, Near-RT RIC 40 or the like). Referring to FIG. 16, the Near-RT RIC 40 and the like include a network interface 1201, a processor 1202, and a memory 1203. The network interface 1201 may be used to communicate with network nodes. The network interface 1201 may include, for example, a network interface card (NIC) conforming to IEEE 802.3 series. Here, the IEEE represents Institute of Electrical and Electronics Engineers.

The processor 1202 executes the processing of the Near-RT RIC 40 and the like described using the flowcharts in the above-described example embodiments, by reading a software component (computer programs) from the memory 1203 and executing the software component. The processor 1202 may be, for example, a microprocessor, a micro processing unit (MPU), or a central processing unit (CPU). The processor 1202 may include a plurality of processors.

The memory 1203 includes a combination of a volatile memory and a nonvolatile memory. The memory 1203 may include a storage disposed away from the processor 1202. In this case, the processor 1202 may access the memory 1203 through an input/output (I/O) interface (not illustrated).

In the example in FIG. 16, the memory 1203 is used to store a group of software modules. The processor 1202 is capable of performing the processing of the Near-RT RIC 40 and the like described in the above-described example embodiments by reading and executing the group of software modules from the memory 1203.

As described with reference to FIG. 16, each of the processors included in the Near-RT RIC 40 and the like in the aforementioned example embodiments executes one or a plurality of programs including a group of commands for causing a computer to perform the algorithms described using the drawings.

In the example described above, the program includes a group of commands (or software codes) for causing a computer to execute one or more functions described in the example embodiments in a case where the program is read by the computer. The program may be stored in a non-transitory computer readable medium or a tangible storage medium. As an example and not by way of limitation, the computer readable medium or the tangible storage medium includes a random access memory (RAM), a read only memory (ROM), a flash memory, a solid-state drive (SSD) or any other memory technology, a CD-ROM, a digital versatile disc (DVD), a Blu-ray (registered trademark) disc or any other optical disk storage, a magnetic cassette, a magnetic tape, a magnetic disk storage, and any other magnetic storage device. The program may be transmitted through a transitory computer readable medium or a communication medium. As an example and not by way of limitation, the transitory computer-readable medium or the communication medium includes an electrical signal, an optical signal, an acoustic signal, or any other form of propagated signal.

Note that the technical ideas of the present disclosure are not limited to the above example embodiment and can be appropriately modified without departing from the scope.

Some or all of the above-described example embodiments may be described as in the following Supplementary Notes, but are not limited to the following Supplementary Notes.

### Supplementary Note 1

A communication apparatus that communicates with a Radio Access Network Intelligent Controller (RIC), including:
a reception unit configured to receive a request message for requesting to report measurement data related to a transport block transmitted between the communication apparatus and at least one communication terminal in association for each communication terminal, from the RIC; and
a transmission unit configured to transmit a message including the measurement data associated for each communication terminal to the RIC, in a case where receiving the request message.

### Supplementary Note 2

The communication apparatus according to supplementary note 1, in which the request message includes information that designates the communication terminal to which the measurement data is to be reported.

### Supplementary Note 3

The communication apparatus according to supplementary note 2, in which the request message further includes a measurement item related to the communication terminal to be a report target.

### Supplementary Note 4

The communication apparatus according to supplementary note 3, in which the measurement item related to the communication terminal is an item used to measure an error occurrence rate of a transport block.

### Supplementary Note 5

The communication apparatus according to any one of supplementary notes 2 to 4, in which the request message includes a first format to which information that designates the communication terminal is able to be set, among a plurality of formats that defines an action executed by the communication apparatus.

### Supplementary Note 6

The communication apparatus according to supplementary note 5, in which
the communication apparatus is an E2 node,
the request message is an RIC SUBSCRIPTION REQUEST message transmitted between the RIC and the communication apparatus, and
the RIC SUBSCRIPTION REQUEST message includes an E2SM-KPM Action Definition Format 2, an E2SM-KPM Action Definition Format 3, an E2SM-KPM Action Definition Format 4, or an E2SM-KPM Action Definition Format 5, as the first format to which the information that designates the communication terminal and the measurement item related to the communication terminal are set.

### Supplementary Note 7

An RIC including:
a transmission unit configured to transmit a request message for requesting to report measurement data related to a transport block transmitted between a communication apparatus and at least one communication terminal in association for each communication terminal, to the communication apparatus; and
a reception unit configured to receive a message including the measurement data associated for each communication terminal, from the communication apparatus that has received the request message.

### Supplementary Note 8

The RIC according to supplementary note 7, in which the request message includes information that designates the communication terminal to which the measurement data is to be reported.

### Supplementary Note 9

The RIC according to supplementary note 8, in which the request message further includes a measurement item related to the communication terminal to be a report target.

### Supplementary Note 10

The RIC according to supplementary note 9, in which the measurement item related to the communication terminal is an item used to measure an error occurrence rate of a transport block.

### Supplementary Note 11

The RIC according to any one of supplementary notes 8 to 10, in which the request message includes a first format to which information that designates the communication terminal is able to be set, among a plurality of formats that defines an action executed by the communication apparatus.

### Supplementary Note 12

The RIC according to supplementary note 11, in which
the communication apparatus is an E2 node,
the request message is an RIC SUBSCRIPTION REQUEST message transmitted between the RIC and the communication apparatus, and
the RIC SUBSCRIPTION REQUEST message includes an E2SM-KPM Action Definition Format 2, an E2SM-KPM Action Definition Format 3, an E2SM-KPM Action Definition Format 4, or an E2SM-KPM Action Definition Format 5, as the first format to which the information that designates the communication terminal and the measurement item related to the communication terminal are set.

### Supplementary Note 13

A method executed by a Radio Access Network Intelligent Controller (RIC), the method including:
a step of transmitting a request message for requesting to report measurement data related to a transport block transmitted between a communication apparatus and at least one communication terminal in association for each communication apparatus, to the communication terminal; and
a step of receiving a message associated with the measurement data for each communication terminal, from the communication apparatus that has received the request message.

### Supplementary Note 14

A program for causing a computer to execute processing including:
transmitting a request message for requesting to report measurement data related to a transport block transmitted between a communication apparatus and at least one communication terminal in association for each communication terminal, to the communication apparatus; and
receiving a message including the measurement data associated for each communication terminal, from the communication apparatus that has received the request message.

### Supplementary Note 15

A method executed by a communication apparatus including:
a step of receiving a request message for requesting to report measurement data related to a transport block transmitted between the communication apparatus and at least one communication terminal in association for each communication terminal, from a Radio Access Network Intelligent Controller (RIC); and
a step of transmitting a message including the measurement data associated for each communication terminal to the RIC, in a case where receiving the request message.

### Supplementary Note 16

A program for causing a computer to execute processing including:
receiving a request message for requesting to report measurement data related to a transport block transmitted between the communication apparatus and at least one communication terminal in association for each communication terminal, from a Radio Access Network Intelligent Controller (RIC); and
transmitting a message including the measurement data associated for each communication terminal to the RIC, in a case where receiving the request message.

### Supplementary Note 17

A communication system including: a Radio Access Network Intelligent Controller (RIC); and a communication apparatus, in which
the RIC transmits a request message for requesting to report measurement data related to a transport block transmitted between the communication apparatus and at least one communication terminal in association for each communication terminal, to the communication apparatus, and
the communication apparatus transmits a message including the measurement data associated for each communication terminal to the RIC, in a case where receiving the request message.

### Supplementary Note 18

The communication system according to supplementary note 17, in which the RIC transmits the request message including information that designates the communication terminal to which the measurement data is to be reported, to the communication apparatus.

### Supplementary Note 19

The communication system according to supplementary note 18, in which the RIC transmits the request message further including a measurement item related to the communication terminal to be a report target, to the communication apparatus.

### Supplementary Note 20

The communication system according to supplementary note 19, in which the measurement item related to the communication terminal is an item used to measure an error occurrence rate of a transport block.

### Supplementary Note 21

The communication system according to any one of supplementary notes 18 to 20, in which the request message includes a first format to which information that designates the communication terminal is able to be set, among a plurality of formats that defines an action executed by the communication apparatus.

### Supplementary Note 22

The communication system according to supplementary note 21, in which
the communication apparatus is an E2 node,
the request message is an RIC SUBSCRIPTION REQUEST message transmitted between the RIC and the communication apparatus, and the RIC SUBSCRIPTION REQUEST message includes an E2SM-KPM Action Definition Format 2, an E2SM-KPM Action Definition Format 3, an E2SM-KPM Action Definition Format 4, or an E2SM-KPM Action Definition Format 5, as the first format to which the information that designates the communication terminal and the measurement item related to the communication terminal are set.

### Supplementary Note 23

A management apparatus including:
a transmission unit configured to transmit a request message for requesting to report measurement data related to a transport block transmitted between a communication apparatus and at least one communication terminal for each communication terminal, to the communication apparatus; and
a reception unit configured to receive a message related to the measurement data for each communication terminal, from the communication apparatus that has received the request message.

Some or all of the elements (such as configurations and functions, for example) described in Supplementary Notes 2 to 6 depending from Supplementary Note 1 may depend from Supplementary Notes 15 and 16 as well with depending relationships similar to those of Supplementary Notes 2 to 6. Some or all of the elements (such as configurations and functions, for example) described in Supplementary Notes 8 to 12 depending from Supplementary Note 7 may depend from Supplementary Notes 13 and 14 as well with depending relationships similar to those of Supplementary Notes 8 to 12. Some or all of the elements described in any supplementary note may be applied to various types of hardware components, software components, recording means for recording software, systems, and methods.

Although the present disclosure has been described hitherto with reference to the example embodiments, the present disclosure is not limited to the example embodiments described above. Various modifications that can be understood by those skilled in the art can be made to the configurations and details of the present disclosure within the scope of the present disclosure. Each example embodiment can be appropriately combined with another example embodiment.

Each of the drawings or figures is merely an example to illustrate one or more example embodiments. Each drawing is not associated with only one specific example embodiment, but may be associated with one or more other example embodiments. As those ordinary skilled in the art will appreciate, various features or steps described with reference to any one of the drawings may be combined with features or steps illustrated in one or more other drawings, for example, to create an example embodiment that is not explicitly illustrated or described. All of the features or steps illustrated in any one of the drawings for describing illustrative example embodiments are not necessarily mandatory, and some features or steps may be omitted. The order of the steps described in any of the figures may be changed as appropriate.

This application claims priority based on Japanese Patent Application No. 2022-179653 filed on Nov. 9, 2022, the entire disclosure of which is incorporated herein.

### REFERENCE SIGNS LIST

10 COMMUNICATION SYSTEM
20 RIC
21 TRANSMISSION UNIT
22 RECEPTION UNIT
30 COMMUNICATION APPARATUS
31 RECEPTION UNIT
32 TRANSMISSION UNIT
40 NEAR-RT RIC
41 CONTROL UNIT
42 COMMUNICATION UNIT
50 E2 NODE
60 O-CU
70 O-DU
71 CONTROL UNIT
72 COMMUNICATION UNIT
80 O-RU
90 SMO
100 NON-RT RIC
110 UE

What is claimed is:

1. A communication apparatus that communicates with a Radio Access Network Intelligent Controller (RIC), the communication apparatus comprising:
at least one memory storing instructions; and
at least one processor configured to execute the instructions to,
receive a RIC SUBSCRIPTION REQUEST message for requesting to report measurement data related to a transmission error of a physical layer in at least one communication terminal in association for each communication terminal, from the RIC; and
transmit a RIC Indication message including the measurement data associated for each communication terminal to the RIC, after receiving the RIC SUBSCRIPTION REQUEST message.

2. The communication apparatus according to claim 1, wherein the RIC SUBSCRIPTION REQUEST message includes information that designates the communication terminal to which the measurement data is to be reported.

3. The communication apparatus according to claim 2, wherein the RIC SUBSCRIPTION REQUEST message further includes a measurement item related to the communication terminal to be a report target.

4. The communication apparatus according to claim 3, wherein the measurement item related to the communication terminal is an item used to measure an error occurrence rate of a transport block.

5. The communication apparatus according to claim 2, wherein the RIC SUBSCRIPTION REQUEST message includes a first format to which information that designates the communication terminal is able to be set, among a plurality of formats that defines an action executed by the communication apparatus.

6. The communication apparatus according to claim 1, wherein the communication apparatus is an E2 node.

7-12. (canceled)

13. A method executed by a Radio Access Network Intelligent Controller (RIC), the method comprising:
transmitting a RIC SUBSCRIPTION REQUEST message for requesting to report measurement data related to a transmission error of a physical layer in at least one communication terminal in association for each communication terminal, to the communication apparatus; and
receiving a RIC Indication message including the measurement data associated for each communication terminal, from the communication apparatus that has received the RIC SUBSCRIPTION REQUEST message.

14. The method according to claim 13, wherein the RIC SUBSCRIPTION REQUEST message includes information that designates the communication terminal to which the measurement data is to be reported.

15. The method according to claim 14, wherein the RIC SUBSCRIPTION REQUEST message further includes a measurement item related to the communication terminal to be a report target.

16. (canceled)

17. A method executed by a communication apparatus comprising:
a step of receiving a RIC SUBSCRIPTION REQUEST message for requesting to report measurement data related to a transmission error of a physical layer in at least one communication terminal in association for each communication terminal, from a Radio Access Network Intelligent Controller (RIC); and
transmitting a RIC Indication message including the measurement data associated for each communication terminal to the RIC, after receiving the RIC SUBSCRIPTION REQUEST message.

18. The method according to claim 17, wherein the RIC SUBSCRIPTION REQUEST message includes information that designates the communication terminal to which the measurement data is to be reported.

19. The method according to claim 18, wherein the RIC SUBSCRIPTION REQUEST message further includes a measurement item related to the communication terminal to be a report target.

20. (Canceled)

21. The method according to claim 19, wherein the measurement item related to the communication terminal is an item used to measure an error occurrence rate of a transport block.

22. The method according to claim 18, wherein the RIC SUBSCRIPTION REQUEST message includes a first format to which information that designates the communication terminal is able to be set, among a plurality of formats that defines an action executed by the communication apparatus.

23. The method according to claim 17, wherein
the communication apparatus is an E2 node.

24. The method according to claim 15, wherein the measurement item related to the communication terminal is an item used to measure an error occurrence rate of a transport block.

25. The method according to claim 14, wherein the RIC SUBSCRIPTION REQUEST message includes a first format to which information that designates the communication terminal is able to be set, among a plurality of formats that defines an action executed by the communication apparatus.

26. The method according to claim 13, wherein the communication apparatus is an E2 node.
